(19) United States
(12) Patent Application Publication
(10) Pub. No.: US 2018/0153339 A1
(43) Pub. Date: Jun. 7, 2018

(54) MICROWAVE BACON COOKER WITH LID

(71) Applicant: William George Hinrichsen, Boquete (PA)

(72) Inventor: William George Hinrichsen, Boquete (PA)

(21) Appl. No.: 15/368,818

(22) Filed: Dec. 5, 2016

(51) Int. Cl. A47J 36/02; A47J 36/06; A47J 36/08

(52) U.S. Cl. CPC A47J 36/027; A47J 36/08; A47J 36/06

(57) ABSTRACT

A structure for cooking strips of bacon in a microwave oven in a safer and cleaner way. The structure consists of three parts, the base receptacle, which collects the grease produced during the cooking process; the cooking platform, which presents a lattice style surface over which the strips of bacon are placed to be cooked. This cooking platform is positioned directly inside the base receptacle so that hot liquid grease from the bacon drains into the base receptacle; and a ventilation lid which extends over the open upper end of the base receptacle to prevent the splatter of grease inside the microwave oven and to further protect the user from sizzling grease when the cooker is removed from the microwave.

### FIELD OF INVENTION

The present invention relates to cookware, more particularly to a microwave cooking system specifically designed for cooking strips of bacon in a microwave oven in a safe and clean manner.

### DESCRIPTION OF PRIOR ART

Cooking vessel for microwave oven cookery adapted to aid in browning foods by heat from hot, liquid fats disclosed by Mason et al. in U.S. Pat. No. 4,140,889; Structure for use in microwave cooking disclosed by James F Kubiatowicz in U.S. Pat. No. 4,343,978; Microwave bacon cooker device and method disclosed by Kelly et al. in U.S. Pat. No. 5,714,740; Microwave cooking vessel with removable food supports and storage clip disclosed by Fleck et al. in U.S. Pat. No. 5,837,979; Bacon cooker disclosed by Hechler IV in U.S. Pat. No. 6,211,502; Microwave cooking rack disclosed by Wong et al. in U.S. Pat. No. 6,448,542; Apparatus for cooking bacon and the like disclosed by Hechler IV in the U.S. Pat. No. 7,005,621; Microwave cooking tray with multiple floor patterns disclosed by Hopkins in U.S. Pat. No. 7,141,771; Method for safe and uniform microwave cooking of food article disclosed by Hechler IV in U.S. Pat. No. 7,345,263; Bacon cooker disclosed by Sabrena Wright in U.S. patent application No. US 2003/0180426; Tiered-bacon cooking, grease-draining device with pour spout for microwave oven as disclosed by Eckley et al. in U.S. Pat. No. D514,874 S; Apparatus for cooking bacon and other flat strips of food disclosed by Matthew Ternmerman in U.S. patent application No. U.S.2010/0077929; Microwave cooking system disclosed by Paul Dilonardo disclosed in U.A. patent application No. 2014/0072680.

While these described systems fulfill their respective individual purposes, the aforementioned patents do not describe a microwave bacon cooker having a base receptacle, a cooking platform that keeps the hot grease drippings away from the bacon, and a ventilation lid to allow the steam generated during the cooking process to exit the container and simultaneously protect the splattering of grease inside the microwave oven, and protect the user from sizzling grease when the cooker is removed from the microwave. Additionally, some of the previous art are only suitable for cooking other types of foods but not for strips of bacon.

Further, some styles of bacon cookers cook the bacon in the liquid fat because the ribs or grooves where the bacon strips sit are not tall enough to prevent the bacon from sagging into the fat that drips from the bacon during the cooking process. Trays for cooking bacon in a microwave oven generally consist of a tray having a slightly angled surface onto which strips of bacon are placed. The angled surface contains a series of grooves or ribs which allows the grease to drip from the bacon during the cooking process and collect in a reservoir below the angled surface. A drawback with this design is that grease gets trapped behind the grooves or ribs and does not completely accumulate in a reservoir area. Further, these grooves make the cleaning of the tray very difficult resulting in a time and work intensive process.

Therefore, there is a need for a new and improved microwave bacon cooking system. In this respect this invention departs from the conventional systems and designs of the prior art.

### SUMMARY OF THE INVENTION

The present invention provides the means to microwave strips of bacon suspended in a cooking platform thus keeping them away from the accumulation of hot liquid grease that results from the cooking process.

Another purpose of the present Invention is to deliver a novel and improved system for cooking strips of bacon in a microwave oven providing a safer and cleaner manner during the cooking process.

The present invention includes an elevated lattice style cooking surface allowing for the strips of bacon to cook more evenly by exposing all sides to the effects of the microwaves. Additionally, because of this elevation the strips of bacon do not cook in the grease created by the dripping process thus contributing to a healthier food preparation. The grease is collected in a base receptacle thus keeping it away from the bacon. The base receptacle has a pour spout for ease of draining and disposal of the hot liquid grease that has accumulated on the base receptacle during the cooking process.

The entire structure is covered with a ventilation lid to allow steam to escape, prevent grease splattering inside the microwave oven and to further protect the user from sizzling grease when the cooker is removed from the microwave.

The entire structure may be manufactured from any suitable material used in cooking in microwave ovens.

### BRIEF DESCRIPTION OF THE DRAWINGS

The invention will be become more readily understood when consideration is given to the following detailed description when taken together with the accompanying drawings, wherein:

FIG. 1 is a perspective view of the base receptacle of the microwave bacon cooker which houses the cooking platform and supports the ventilation lid;

FIG. 2 is a perspective view of the cooking platform of the microwave bacon cooker;

FIG. 3 is a perspective view of the ventilation lid of the microwave bacon cooker;

FIG. 4-A through 4-D inclusive are perspective views of all three elements (FIG. 4-A) of the microwave bacon cooker system whereas the cooking platform rests on four legs inside the base receptacle (FIG. 4-B), and the ventilation lid covers the top of the base receptacle (FIG. 4-C) and, when assembled together, comprise the entire microwave bacon cooker system with lid (FIG. 4-D).

### DETAILED DESCRIPTION OF THE EMBODIMENT

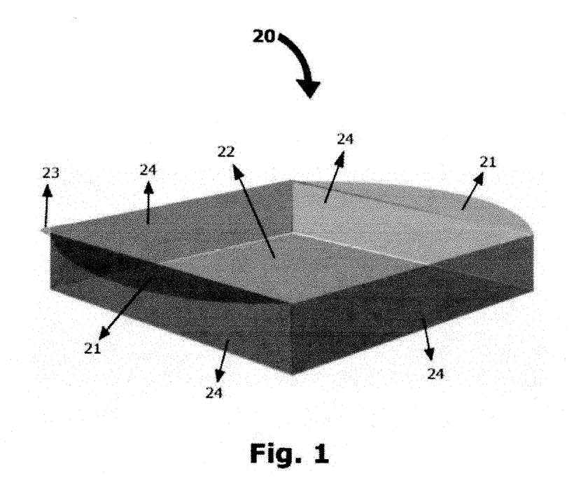

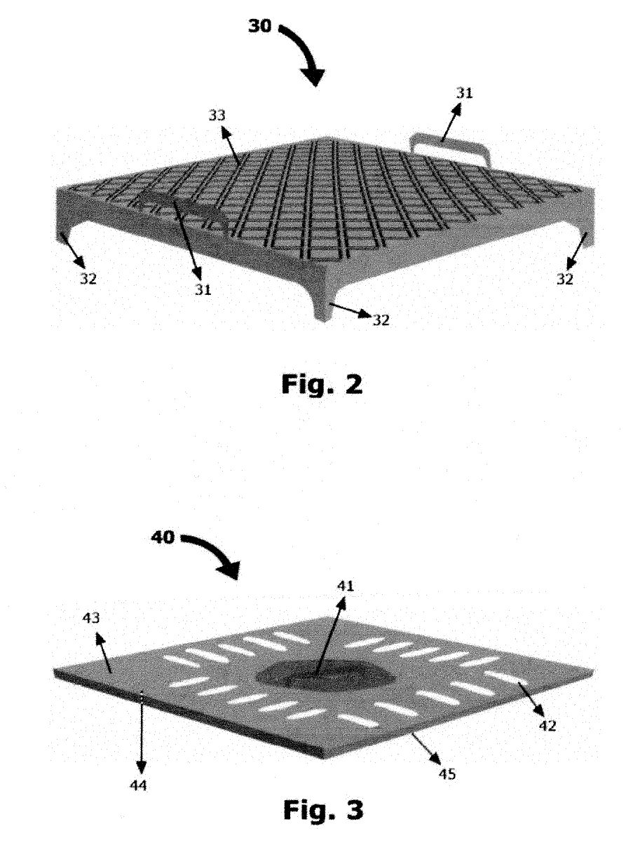

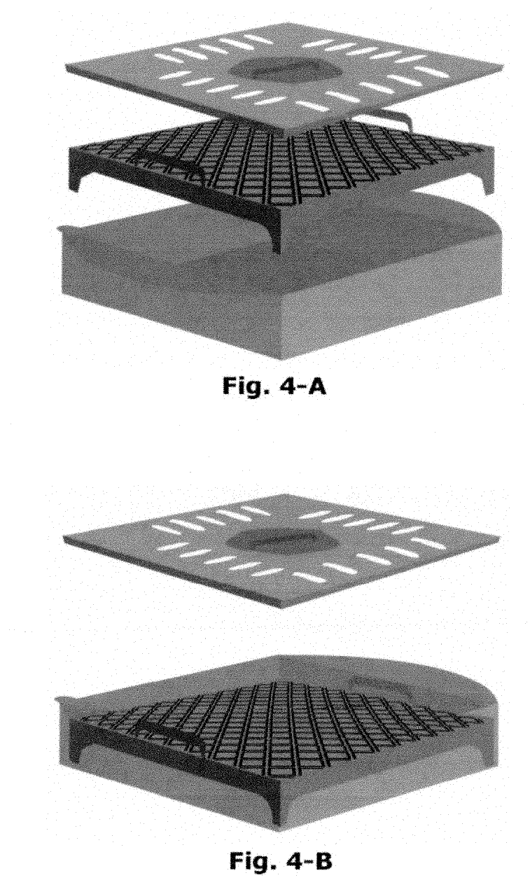

Referring to the drawings, FIGS. 1 to 3 of the microwave bacon cooker system designated by the numeral 10. The embodiment of the microwave bacon cooker system 10 comprises: a base receptacle 20 (FIG. 1), the cooking platform 30 (FIG. 2), and a ventilation lid 40 (FIG. 3). The base receptacle 20 is shaped to have a centrally located cavity 22 created by four walls 24 joined to the appropriate sides of the base receptacle 20. There is a pair of opposing hand grips 21 extending horizontally away from two opposing sidewalls 24 of the base receptacle 20, and a pour spout 23 at one corner formed by the intersection of two sidewalls 24 of the base receptacle 20. The cooking platform 30 which is sized to fit inside the cavity 22 of the base receptacle 20 has four legs 32 at each one of the corners of the cooking platform 30, and two opposing handles 31 extending vertically away from the upper edge of the cooking platform 30. Additionally, the cooking platform 30 has a cooking surface 33 consisting of a lattice type design to support the strips of bacon during the cooking process which allows the drippings of hot liquid grease to fall into the cavity 22 of the base receptacle 20. The ventilation lid 40 has an upper surface 43 and a lower surface 44 and steam vents 42 around its entire perimeter and a handle 41 in the center of the upper surface 43 for ease of placement and removal. Additionally, the ventilation lid 40 is sized to mount on top of the base receptacle 20. Further, the ventilation lid 40 has an under-hanging perimeter lip 45 on the lower surface 44 which is sized to sit inside of the cavity 22 of the base receptacle 20 to prevent the ventilation lid 40 from sliding off.

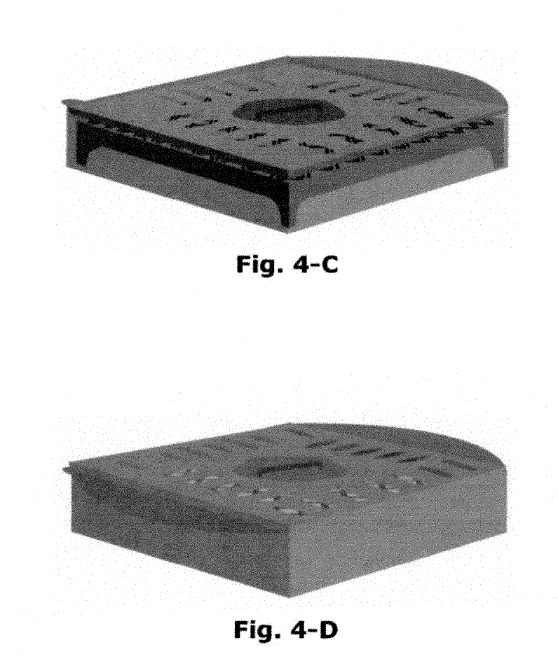

As further explanation and visual reference of the embodiment of the microwave bacon cooker system 10, FIGS. 4-A through 4-D illustrate how the various individual components of the microwave bacon cooker system 10 fit with each other to provide the embodiment as described above in Detailed Description of the Embodiment.

Although a description and illustration of the microwave bacon cooker system has been described and shown in detail, it should be apparent that modifications and variations thereto are possible. For example, all the interior angles of the base receptacle could be rounded, and while the invention shows a preferred square shape for all its individual components, however, other geometric shapes such as rectangular, circular, oval, etc. are possible, all of which fall within the true spirit and scope of the invention. Additionally, variations in size, materials, form, function and manner of operation and use, are intended to be encompassed by the present invention.

Consequently, the foregoing is considered as illustrative only of the principles of the invention and it is not desired to limit the invention to the exact construction and operation shown as described and, therefore, all suitable modifications and equivalents that may be resorted to, will fall within the scope of the invention.

What is claimed is:

1. A microwave strip bacon cooker system with lid comprising:
a base receptacle having a centrally located cavity;
a cooking platform sized to be positioned inside the central cavity of the base receptacle;
a ventilation lid having a plurality of steam vents around its perimeter, and the ventilation lid sized to mount on top of the base receptacle to cover the central cavity of the base receptacle.

2. The microwave bacon cooker system of claim 1, wherein:
the base receptacle is generally square in shape, having a bottom with an upper interior surface and a lower exterior surface, four sidewalls around the perimeter extending upwardly from the bottom surface;

3. The base receptacle of claim 2 wherein there are two handles attached to the top of two side walls each one located at opposite ends of each other and extending away horizontally from the two walls;

4. The base receptacle of claim 2 wherein all four side walls, and the upper surface of the bottom have smooth interior surfaces for ease of cleaning;

5. The base receptacle of claim 2 wherein the lower exterior surface is flat to provide stability when the bacon cooker system sits inside a microwave oven with a flat surface and also to provide good stability when the bacon cooker system sits inside a microwave oven with a turntable;

6. The microwave bacon cooker system of claim 1, wherein:
The cooking platform has four supporting legs extending away from the lower surface of the cooking platform at each of the four corners of the cooking platform;

7. The cooking platform of claim 6 wherein the cooking surface consists of a lattice style surface to allow the drippings from the strips of bacon to fall through the openings onto the base receptacle for collection and disposal of the hot liquid fat;

8. The cooking platform of claim 6 wherein there are two handles attached to the top of the cooking platform each one located at opposite ends of each other and extending away perpendicularly to the cooking platform;

9. The microwave bacon cooker system of claim 1, wherein:
The ventilation lid having a plurality of steam vents around its perimeter;

10. The ventilation lid of claim 9 wherein the lid has been sized to sit on top of the central cavity and where the ventilation lid has an under-hanging perimeter lip on the lower surface which is sized to be positioned inside the central cavity of the base receptacle to prevent the ventilation lid from sliding off;

11. The ventilation lid of claim 9 wherein there is a handle located in the center of the lid for ease of placement and removal;

12. Any material suitable for microwave oven cooking can be employed in the construction of the invention.
